(19) United States
(12) Patent Application Publication
(10) Pub. No.: US 2006/0019669 A1
(43) Pub. Date: Jan. 26, 2006

(54) Cellular mobile communication system and method using heterogeneous wireless network

(75) Inventors: Sang-Jun Moon, Yongin-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/185,792

(22) Filed: Jul. 21, 2005

(30) Foreign Application Priority Data
Jul. 21, 2004 (KR) 2004-56962

(51) Int. Cl. H04Q 7/20

(52) U.S. Cl. 455/447

(57) ABSTRACT

A cellular mobile communication system and method using a heterogeneous wireless network are provided. The system includes a first wireless network providing a wireless resource using a first wireless frequency band, a first device of a cellular network connected with the first wireless network through a wire network, and a terminal setting a tunnel with the first device of the cellular network using the wireless resource of the first wireless network and connected to the cellular network through the set tunnel to perform cell processing.

### CLAIM OF PRIORITY

This application claims benefit under 35 U.S.C. §119(a) from an application filed in the Korean Intellectual Property Office on Jul. 21 2005, Serial No. 2004-56962, the entire disclosure of which is hereby incorporated by reference.

### BACKGROUND OF THE INVENTION

1. Field of the Invention

The present invention relates to a heterogeneous network, and more specifically, the present invention relates to a cellular mobile communication system and method using a heterogeneous wireless network, in which connection to a cellular service network can be made using a wireless resource of a wireless network using a wireless frequency other than a cellular frequency of the cellular mobile communication system, without using a cellular service-dedicated wireless resource, thereby providing a cellular service.

2. Description of the Related Art

A cellular mobile communication system is based on the concept of overcoming a limited service area and a limited subscriber capacity. In the cellular mobile communication system, a service area is divided into several smaller zones called cells so that the same frequency band can be used in two cells separated by a sufficient distance, thereby spatially reusing frequency. Accordingly, the cellular mobile communication system can secure sufficient subscribers by increasing the number of spatially distributed channels.

FIG. 1 shows a network structure for a cellular mobile communication system.

Referring to FIG. 1, the cellular mobile communication system includes a Base Station Controller (BSC) 5, a Base Transceiver System (BTS) 6, and a cellular terminal 7.

The BTS 6 performs two-way conversion between wired and wireless signals, covers one cell/sector area, and manages a plurality of terminals 7 included in the cell/sector area.

The BSC 5 manages and controls the BTSs 6. In detail, the BSC 5 assigns and de-assigns a wireless channel for each cellular terminal 7, controls a transmission output of the cellular terminal 7 and the BTS 6, performs a soft handoff between cells and determines a hard handoff between the cells, performs a function of transcoding (16 kbps⇄64 kbps) and vocoding (13 kbps, 8 kbps), performs a function of GPS clock distribution for handoff and signal processing, and performs management and maintenance for the BTS 6.

The BSC 5 is connected to an MSC 3, which is a voice core network connected with a Public Switched Telephone Network (PSTN) 4 for voice communication, and to a Packet Data Serving Node (PDSN) 2 which is a data core network connected to the Internet 1 and performing data communication.

The MSC 3 performs an exchange function for voice communication using the cellular mobile communication system, and the PDSN 2 performs a packet exchange function for data communication using the cellular mobile communication system.

In the cellular mobile communication system, call processing between the cellular terminal 7 and the BTS 6 is classified into two kinds: call processing of the cellular terminal 7 and call processing of the BTS 6.

The call processing of the BTS 6 includes pilot and synch channel processing, paging channel processing, access channel processing, and traffic channel processing. During pilot channel processing, the BTS 6 transmits a pilot channel signal. During traffic channel processing, the BTS 6 communicates with the cellular terminal 7, which is in a mobile station control on the traffic channel state, using forward and reverse traffic channels. During the access channel processing, the BTS 6 monitors an access channel and receives messages from the cellular terminal 7 in a system access state. During the paging channel processing, the BTS 6 transmits messages on a paging channel monitored by the cellular terminal 7 which is in the system access state or an idle state.

In the cellular terminal 7, the call processing is performed at four terminal states: an initialization state, the idle state, the system access state, and the mobile station control on the traffic channel state. In the initialization state, the cellular terminal 7 selects and acquires a mobile communication system for communication. In the system access state, the cellular terminal 7 transmits messages to the BTS 6 on the access channel, and receives messages from the BTS 6 on the assigned paging channel. In the mobile station control on the traffic channel state, the cellular terminal 7 communicates with the BTS 6 through the forward and reverse traffic channels.

Wireless Local Area Network (WLAN) is designed to enable a high-speed wireless data service based on Ethernet. The WLAN has been utilized as a network solution that is useful for a factory, a conference room, a showroom, and the like in which it is difficult to set up network cables.

The WLAN is based on radio waves, not cable as in a wire LAN. The WLAN which employs radio waves has a longer communication ranges than a network employing infrared rays, and has no difficulty in data exchange even if there are minor obstacles. A 2.4 GHz frequency band of the WLAN is different from a frequency band of wireless devices such as portable phones and cordless phones, and accordingly, the WLAN is not affected by line-crossing, and also does not require a service license. Further, the WLAN can be used at any location since it does not need a WLAN cable.

FIG. 2 shows a construction of a WLAN system.

Referring to FIG. 2, the WLAN system includes a WLAN terminal 15 having a Network Interface Card (NIC) mounted therein; a WLAN access point 14 for wirelessly communicating with the WLAN terminal 15 using the WLAN frequency; a router 13 for connecting the access point 14 to an external network; and a gateway 12 for connecting the access point 14 to the Internet 11 through the router 13.

In a definition of a WLAN Media Access Control (MAC) of IEEE 802.11, the access point 14 performs authentication and association to manage its WLAN service area.

In other words, when the WLAN terminal 15 requests a call connection, the access point 14 receives information on call connection, that is, information on Internet Protocol (EP), gateway, and Domain Name Server (DNS) previously set to the WLAN terminal 15, from the corresponding WLAN terminal 15, requests the gateway 12 for connection authentication through the router 13, and performs a function of WLAN relay for the call connection.

If a registered member identifier (ID) and password are input through the WLAN terminal 15, the WLAN terminal 15 is authenticated for the call connection in the gateway 12. If the gateway 12 permits the connection authentication, the corresponding WLAN terminal 15 sets the wireless link through the access point 14 and connects the call through the gateway 12.

As described above, as the WLAN system and the cellular mobile communication system provide services using different frequency bands, they have been developed as separate systems.

However, as communications technology becomes more ubiquitous, an association technology between various heterogeneous communication networks is required. Accordingly, technology for association between the WLAN system and the cellular mobile communication network is required.

### SUMMARY OF THE INVENTION

Therefore, one of the objectives of the present invention is to provide a cellular mobile communication system and method using a heterogeneous wireless network, which may enable, for example, a cellular mobile communication service under a wireless network environment using wireless frequencies other than a cellular-dedicated frequency, such as a wireless LAN.

According to an exemplary aspect of the present invention, there is provided a cellular mobile communication system using a heterogeneous wireless network, the system including a first wireless network providing a wireless resource using a first wireless frequency band; a first device of a cellular network connected to the first wireless network through a wire network; and a terminal setting a tunnel with the first device of the cellular network using the wireless resource of the first wireless network, and connected to the cellular network through the set tunnel to perform cell processing.

According to another exemplary aspect to the present invention, there is provided a terminal for a cellular mobile communication system using a heterogeneous wireless network, the terminal including a WLAN (Wireless Local Area Network) interface module assigned a wireless resource from a WLAN and communicating with the WLAN using a WLAN-dedicated frequency band; a tunnel processor for setting and managing a tunnel with a first device of a cellular network connected to the WLAN through a wire network using the wireless resource provided from the WLAN through the WLAN interface module; and a call processor connected to the cellular network through the set tunnel, and performing call processing.

According to still another exemplary aspect of the present invention, there is provided a cellular mobile communication method using a heterogeneous wireless network, the method including the steps of transmitting, by a terminal, a tunnel set request message to a first device of a cellular network, which is connected to a first wireless network through a wire network using a wireless resource assigned from the first wireless network; storing, by the first device of the cellular network, terminal information extracted from the received request message and setting the tunnel with the terminal according to the tunnel set request message from the terminal; and connecting, by the terminal, to the cellular network through the tunnel, which is set between the terminal and the first device, and performing call processing.

According to yet another exemplary aspect of the present invention, there is provided a cellular mobile communication method using a heterogeneous wireless network, the method including the steps of transmitting, by a terminal, a tunnel set request message to a first device of a cellular network, which is connected to a first wireless network through a wire network using a wireless resource assigned from the first wireless network; storing, by the first device of the cellular network, terminal information extracted from the received request message and setting the tunnel with the terminal according to the tunnel set request message from the terminal; and connecting, by the terminal, to the cellular network through the tunnel, which is set between the terminal and the first device, and performing call processing.

According to still yet another exemplary aspect of the present invention, there is provided a cellular mobile communication method using a heterogeneous wireless network, the method including the steps of transmitting, by a terminal, a tunnel set request message to an eBTS (enhanced Base Transceiver Station) of a cellular network, which is connected to a first wireless network through a wire network using a wireless resource assigned from the first wireless network; storing, by the eBTS of the cellular network, terminal information extracted from the received request message and setting the tunnel with the terminal according to the tunnel set request message received from the terminal; and connecting, by the terminal, to the cellular network through the tunnel, which is set between the terminal and the eBTS, and performing call processing.

### BRIEF DESCRIPTION OF THE DRAWINGS

A more complete appreciation of the exemplary embodiments of the present invention, and many of the attendant advantages thereof, will be readily apparent by reference to the following detailed description when considered in conjunction with the accompanying drawings, in which like reference symbols indicate the same or similar components, wherein:

FIG. 1 shows an example of a network construction of a cellular mobile communication system;

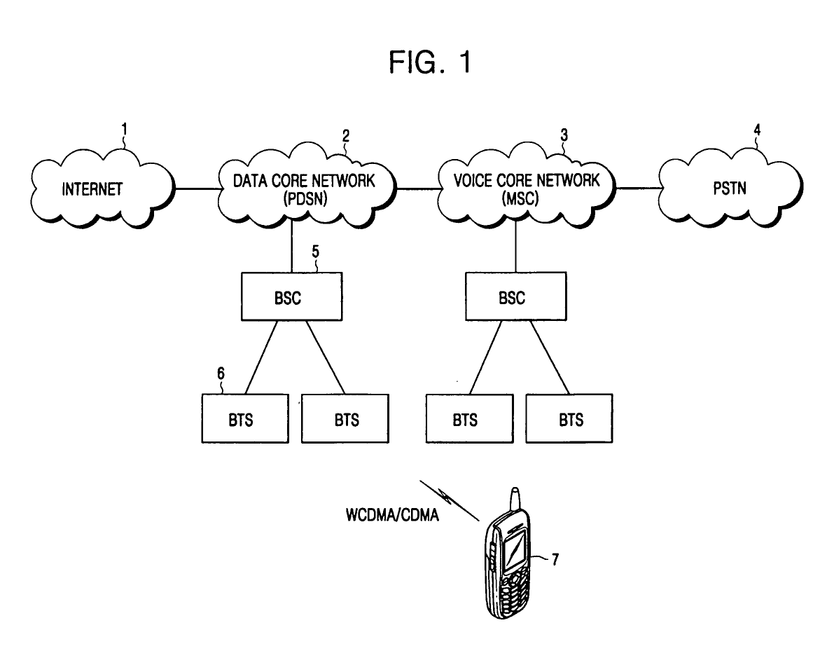

FIG. 2 shows an example of a construction of a wireless LAN system;

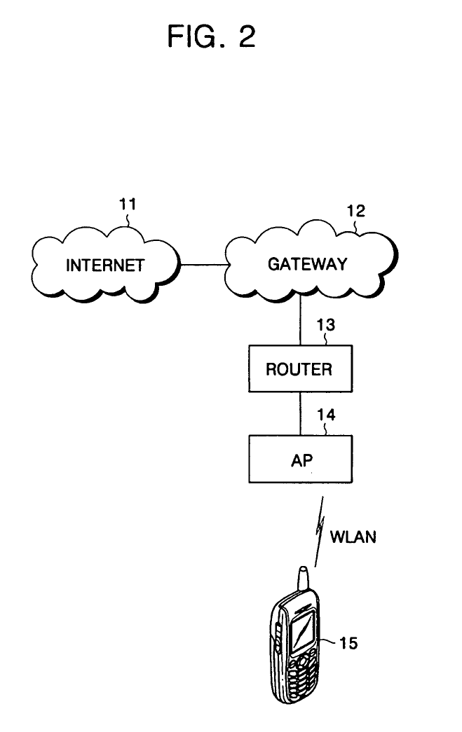

FIG. 3 shows a construction of a cellular mobile communication system using a wireless LAN according to an exemplary embodiment of the present invention;

FIG. 4 shows a construction of a terminal according to an exemplary embodiment of the present invention; and

FIG. 5 shows a construction of a cellular mobile communication system using a wireless LAN according to another exemplary embodiment of the present invention.

### DETAILED DESCRIPTION OF EXEMPLARY EMBODIMENTS

Exemplary implementations of the present invention will now be described with reference to the accompanying drawings, in which exemplary embodiments of the present invention are shown. The exemplary implementation of the present invention may, however, be achieved in different forms and should not be construed as limited to the exemplary embodiments set forth herein. Rather, these exemplary embodiments are described so that skilled artisans may appreciate various, non-limiting, aspects of the present invention. As noted above, throughout the drawings, the same elements are denoted by the same reference numeral.

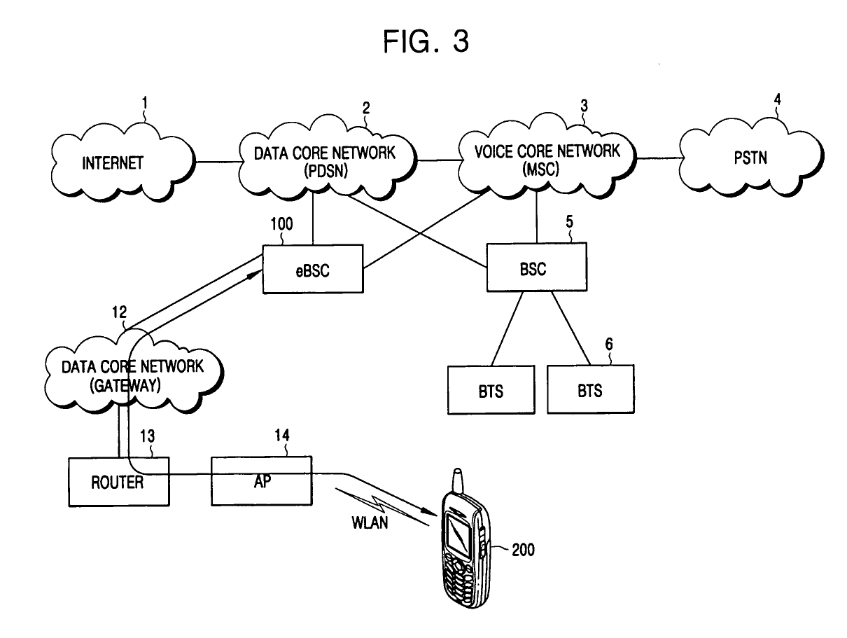

FIG. 3 shows a construction of a cellular mobile communication system using a Wireless Local Area Network (WLAN) according to an exemplary embodiment of the present invention.

Referring to FIG. 3, mobile communication system according to an exemplary embodiment of the present invention includes a terminal 200 having a Wireless Local Area Network (WLAN) interface card mounted therein; an Access Point (AP) 14 for wirelessly communicating with the terminal 200 using a WLAN frequency; a switch or router 13 for connecting the access point 14 to an external network; a gateway 12 for connecting the access point 14 to the Internet through the switch or router 13; and an enhanced Base Station Controller (Hereinafter, referred to as “eBSC”) 100 connected to the gateway 12 through a wire network, and forming a tunnel up to the terminal 200 through the wired network and providing a cellular service to the terminal 200 through the tunnel.

The Wireless Local Area Network (WLAN) interface module is mounted in the terminal 200, and processes a wireless signal at the WLAN frequency. The terminal 200 sets a wireless link with the access point 14 using the WLAN frequency in a WLAN area, and performs a wireless communication through the set wireless link. In the following description of the exemplary embodiment of the present invention, unless stated otherwise, the terminal 200 means a terminal having the WLAN interface module for setting the wireless link with the access point using the WLAN frequency.

The terminal 200 may, for example, be one of two types. In a first type, the terminal 200 includes the WLAN interface module for setting the wireless link using only the WLAN frequency.

In a second type, the terminal 200 concurrently includes the WLAN interface module and a cellular wireless interface module for processing the wireless signal at the cellular frequency. In the second type, the terminal 200 can set the wireless link using the WLAN frequency in the WLAN area, and set the wireless link using a cellular frequency in a cellular area. Accordingly, a terminal of the second type can perform a handover in the WLAN area and the cellular area.

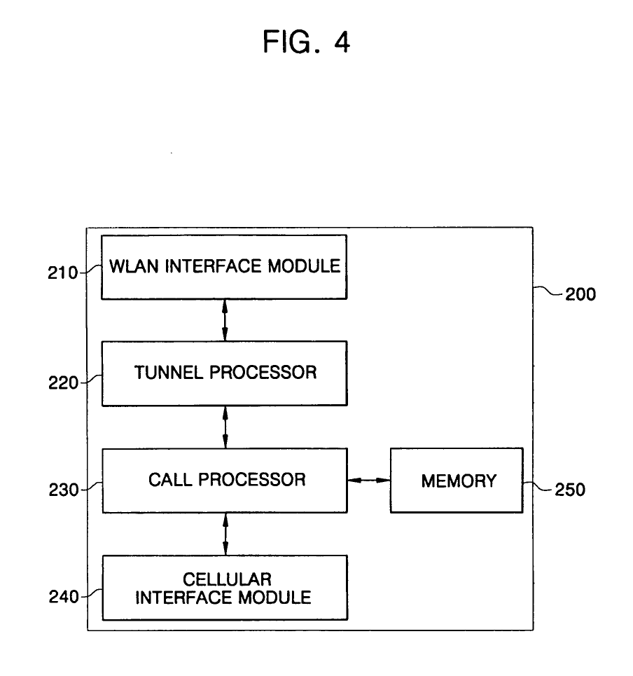

FIG. 4 shows an exemplary construction of a terminal of the second type according to an exemplary embodiment of the present invention.

Referring to FIG. 4, the terminal 200 includes the WLAN interface module 210 assigned the wireless resource from the WLAN and communicating with the WLAN, using a WLAN-dedicated frequency band; a tunnel processor 220 for setting and managing a tunnel with the eBSC 100 of a cellular network connected to the WLAN through the wire network, using the wireless resource provided from the WLAN through the WLAN interface module 210; a call processor 230 connected to the cellular network through the tunnel set by the tunnel processor 220, and performing call processing; a cellular interface module 240 assigned the wireless resource from the cellular network using a cellular-dedicated frequency band, and communicating with the cellular network; and a memory 250 for storing tunnel setting information.

The access point 14 communicates with the terminal 200, using Carrier Sense Multiple Access/Collision Avoidance (CSMA/CA) of IEEE 802.11.

In other words, the access point 14 and the terminal 200 first check whether or not there is a carrier based on the CSMA/CA. If it is determined that there is no carrier (that is, if there is no terminal using a wireless channel), transmission is performed after a lapse of a predetermined time. Since the same transmitter (Tx) or receiver (Rx) uses the same transmission medium, only one of transmission (Tx) and reception (Rx) can be performed at a time.

Further, if there occurs collision with other terminals during transmission, a next carrier is determined using a back-off algorithm.

The eBSC 100 is connected to a Mobile Station Controller (MSC) 3 which is a voice core network connected with a Public Switched Telephone Network (PSTN) 4 and performing a voice communication, and connected to a Packet Data Serving Node (PDSN) 2 which is a data core network connected to Internet 1 and performing a data communication. The MSC 3 performs an exchange function for the voice communication using the cellular mobile communication system, and the PDSN 2 performs a packet exchange function for the data communication using the cellular mobile communication system.

The eBSC 100 manages and controls base stations (not shown), and provides a service for the terminal 200 connected through the WLAN.

In other words, the eBSC 100 assigns and de-assigns the wireless channel to and from a cellular terminal (not shown) for wirelessly communicating using the cellular frequency band, controls a transmission output of the cellular terminal and a Base Transceiver System (BTS) (not shown), performs a soft handoff between cells and determines a hard handoff between the cells, performs a function of trans coding (16 kbps⇄64 kbps) and vocoding (13kbps, 8 kbps), performs a function of GPS clock distribution for handoff and signal processing, and performs management and maintenance for the BTS (not shown).

Further, the eBSC 100 receives information from the terminal 200 connected through the tunnel in the WLAN area, and transmits the received information to the MSC 3 or the PDSN 2.

The terminal 200 receives a beacon from the access point 14 and performs an association process for the access point 14 using the received beacon, and is assigned an IP address from a gateway 12 preferably using Dynamic Host Configuration Protocol (DHCP). After that, the terminal 200 sets the tunnel up to the eBSC 100 using a tunneling method such as User Datagram Protocol (UDP).

An exemplary method for setting the tunnel between the terminal 200 and the eBSC 100 will be described in more detail.

When the terminal 200 uses a UDP tunnel up to the eBSC 100, the terminal 200 transmits a tunnel set request message to the eBSC 100, using the IP address and a UDP port of the eBSC 100.

The request message can include a terminal ID (International Mobile Subscriber Identity (IMSI), IP address, and MAC address) and a user ID (for example, Network Access Identifier (NAI)), and can include information for indicating the type of data (CS signaling, CS data, PS signaling, PS data, and other information).

The eBSC 100 receives the tunnel set request message from the terminal 200, and periodically transmits a message having BSC relation information such as a cell ID to the corresponding terminal 200 having a source port number. By doing so, the UDP tunnel is completed between the terminal 200 and the eBSC 100. Henceforth, the UDP tunnel is maintained and used to exchange necessary information.

In the meantime, when the terminal 200 uses a Generic Route Encapsulation (GRE) tunnel up to the eBSC 100, the terminal 200 transmits a message including the terminal ID, the user ID, and a desired option (the use of a sequence number, the application of encryption, and the like), to the eBSC 100. The eBSC 100 assigns necessary options, and transmits a GRE message using the corresponding option. The terminal 200 receives the GRE message, and transmits a confirmation message to the eBSC 100 using the received GRE message. Accordingly, the GRE tunnel is completed. Henceforth, the GRE tunnel is maintained and used to exchange necessary information.

After the completion of the tunnel, the terminal 200 does not need to separately include the terminal ID and the user ID except for a special case. The eBSC 100 regularly transmits information representing the cell ID and other network states, to the terminal 200 in other formats.

The terminal 200 periodically transmits a position registration message of the cellular service to the eBSC 100. In a case when there is no data to be transmitted, a message is transmitted within a predetermined time so as to maintain the tunnel. When the eBSC 100 does not receive a tunnel maintenance message from the terminal 200, it instantly transmits a registration request message to the terminal 200, and waits for a predetermined time. For example, when the eBSC 100 transmits the registration request message to the terminal 200 over three times and does not receive a response from to the terminal 200, it de-assigns the tunnel with the terminal 200.

If the terminal 200 does not also receive periodical network information from the eBSC 100, it transmits a message requesting the eBSC 100 to instantly send the network information, and waits for a predetermined time. If the terminal 200 does not receive a response from the eBSC 100 after lapse of the predetermined time, it repeats the same operation, for example, repeating three times a request to the eBSC 100 to send the network information. If the terminal 200 still does not receive the network information from the eBSC 100, it de-assigns the tunnel and performs a process of setting a new tunnel.

Whereas in a conventional setting BSC manages the BTS, assigns the wireless channel to the terminal, and controls the transmission output of the base station, according to an exemplary embodiment of the present invention, the eBSC 100 deposits the wireless resource of the WLAN to the WLAN access point 14, without requiring a separate step.

According to an exemplary implementation, WLAN access point 14 may be separated into and realized by a simplified access point and an Access Point Controller (APC), where the APC manages the simplified access point, assigns the wireless channel to the terminal, and controls the transmission output of the simplified access point. In such exemplary implementation, a function of the APC may be also integrated into and embodied in the eBSC 100.

An operation of the access point according to an exemplary embodiment of the present when implemented in a conventional WLAN may be described as follows. The eBSC 100 performs a function of relaying information between the terminal 200 and the MSC 3, and performs an additional function of periodically transmitting the cellular network information linked with the cellular network.

An example of cellular service methodology of the terminal 200, which is positioned in the WLAN area, in the above described exemplary mobile communication system will be described below.

A connection between the eBSC 100 and the MSC 3 according to an exemplary embodiment of the present invention may be analogous to a connection between the conventional BSC and MSC. According to an exemplary embodiment of the present invention, a conventional format for a message, which is communicated for call processing between the BSC and the MSC, may be used.

Conventionally, if the MSC transmits a channel assignment request message to the BSC, the BSC commands the BTS in response to the received channel assignment request message to assign the wireless channel to the terminal, and if the BTS assigns the wireless channel to the terminal, the BSC performs a process of assignment completion for informing the MSC that channel assignment is successfully performed.

Conventionally, channel assignment message is communicated between the MSC and the BSC for channel assignment. According to an exemplary embodiment of the present invention, the channel assignment message is communicated between the eBSC 100 and the MSC 3. According to an exemplary embodiment of the present invention a conventional format may be used for channel assignment message, but not the conventional channel assignment message. Accordingly, in contradistinction to a conventional cellular network, in an exemplary embodiment of the present invention, even though the channel assignment message is communicated, the wireless resource of the cellular network is not assigned. That is because in an exemplary implementation of the present invention, the wireless link uses the wireless resource assigned from the WLAN.

Accordingly, in an exemplary implantation of the present invention, the MSC 3 downloads the channel assignment message to the eBSC 100 to perform a function of informing that the corresponding terminal is called, and the eBSC 100 uploads the response message to the MSC 3 in response to the channel assignment message to perform a function of informing that the terminal recognizes that the terminal is called. Based on the foregoing, an incoming call process will be described below.

If the eBSC 100 receives a paging request message from the MSC 3, it transmits a response request message to the terminal 200. If the terminal 200 responds to the response request message of the eBSC 100, the eBSC 100 checks a response of the terminal 200, and sends a paging response message to the MSC 3. The paging response message includes information on an eBSC's request for setting a trunk channel with the MSC 3. The MSC 3 sends the channel assignment message in response to the paging response message while completing the setting of the trunk channel with the eBSC 100.

As the eBSC 100 and the MSC 3 share the trunk channel information with each other, the eBSC 100 adds information on a trunk channel, which is not in use, to the paging response message transmitted to the MSC 3. Accordingly, the MSC 3 recognizes the trunk channel information, which is added to the paging response message uploaded from the eBSC 100, sets the trunk channel and loads and sends the corresponding trunk channel information in the channel assignment message downloaded to the eBSC 100.

In another example, the MSC 3 may also set the trunk channel, and can load and send the corresponding trunk channel information in the channel assignment message downloaded to the eBSC 100, irrespective of the trunk channel information added to the paging response message uploaded from the eBSC 100. In this case, the trunk channel information can be also included only in the channel assignment message, not in the paging response message.

Next, the eBSC 100 transmits a message having its UDP port information to the terminal 200 in the channel assignment. The terminal 200 stores the UDP port information of the eBSC 100 using the received message, determines the UDP port to be used to transmit a voice signal, includes information on the determined UDP port in a confirmation message responsive to the channel assignment message, and transmits the confirmation message to the eBSC 100.

The eBSC 100 receives the confirmation message, stores the corresponding UDP port information, completes preparation for the voice signal to be transmitted to the terminal 200, using the corresponding UDP port, and transmits a channel assignment completion message to the MSC 3. After that, the MSC 3 completes remaining call processing, and communicates using a Pulse Code Modulation (PCM) voice signal with the eBSC 100 using Time Division Multiplexing (TDM). The eBSC 100 converts the voice signal in a format of EVRC, and communicates with the terminal 200 using the UDP port, which is set through the above-described process.

Next, an outgoing call process will be described below.

The terminal 200 transmits an origination message to the eBSC 100, using the predetermined tunnel. The eBSC 100 receives the origination message from the terminal 200, and sends a CM service request message to the MSC 3 and requests to set the trunk channel with the MSC 3.

The MSC 3 responds to the eBSC 100 using the channel assignment message, and completes the setting of the trunk channel between the MSC 3 and the eBSC 100.

As the eBSC 100 and the MSC 3 share the trunk channel information with each other, the eBSC 100 adds information on a trunk channel, which is not in use, to the CM service request message transmitted to the MSC 3. Accordingly, the MSC 3 recognizes the trunk channel information, which is added to the CM service request message uploaded from the eBSC 100, sets the trunk channel and loads and sends the corresponding trunk channel information on the channel assignment message downloaded to the eBSC 100.

In still another example, the MSC 3 may also set the trunk channel, and can load and send the corresponding trunk channel information in the channel assignment message downloaded to the eBSC 100, irrespective of the trunk channel information added to the CM service request message uploaded from the eBSC 100. In this case, the trunk channel information can be also included only in the channel assignment message, not in the CM service request message.

The eBSC 100 receives the channel assignment message from the MSC 3, and transmits a message having its UDP port information to the terminal 200 in the channel assignment. The terminal 200 stores the UDP port information of the eBSC 100 using the received message, determines the UDP port to be used by itself to transmit a voice signal, includes information on the determined UDP port in a channel assignment confirmation message, and transmits the confirmation message to the eBSC 100. The eBSC 100 receives the confirmation message, stores the corresponding UDP port information, completes a preparation for the voice signal to be transmitted to the terminal 200, using the corresponding UDP port, and transmits a channel assignment completion message to the MSC 3. After that, the MSC 3 completes the remaining call processing, and communicates a Pulse Code Modulation (PCM) voice signal with the eBSC 100 using Time Division Multiplexing (TDM). The eBSC 100 converts the voice signal in a format of EVRC, and communicates with the terminal 200 using the UDP port, which is set through the above process.

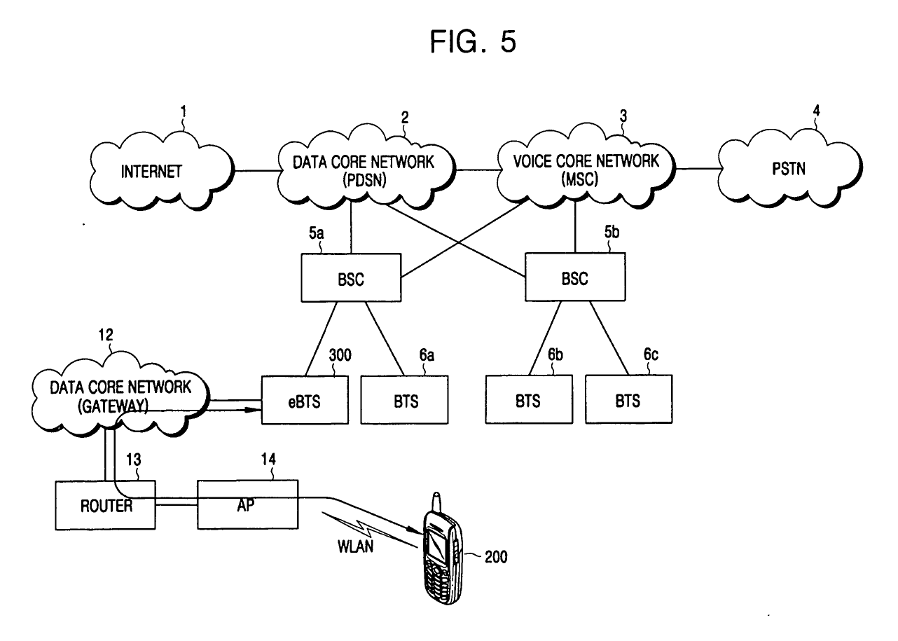

FIG. 5 shows a construction of a cellular mobile communication system using a Wireless Local Area Network (WLAN) according to another exemplary embodiment of the present invention.

Referring to FIG. 5, the inventive cellular mobile communication system includes a terminal 200 having a WLAN interface card mounted therein; an Access Point (AP) 14 for wirelessly communicating with the terminal 200 using a WLAN frequency; a switch or router 13 for connecting the access point 14 to an external network; a gateway 12 for connecting the access point 14 to the Internet through the switch or router 13; and an enhanced Base Transceiver System (Hereinafter, referred to as “eBTS”) 300 connected to the gateway 12 through a wire network, and forming a tunnel up to the terminal 200 through the wire network and providing a cellular service to the terminal 200 through the tunnel.

The WLAN interface module is mounted in the terminal 200, and processes a wireless signal at the WLAN frequency. The terminal 200 sets the wireless link with the access point 14 using the WLAN frequency in a WLAN area, and performs a wireless communication through the set wireless link. In the following description of the exemplary embodiment of the present invention, unless stated otherwise, the terminal 200 means a terminal having the WLAN interface module for setting the wireless link with the access point using the WLAN frequency.

The terminal 200 may be implemented as one of two types. In a first type, the terminal 200 includes the WLAN interface module for setting the wireless link using only the WLAN frequency.

In a second type, the terminal 200 includes the WLAN interface module and a cellular wireless interface module for processing the wireless signal at the cellular frequency. In the second type, the terminal 200 can set the wireless link using the WLAN frequency in the WLAN area, and set the wireless link using a cellular frequency in a cellular area. Accordingly, the second typed terminal can perform a handover in the WLAN area and the cellular area.

The access point 14 communicates with the terminal 200, using Carrier Sense Multiple Access/Collision Avoidance (CSMA/CA) of IEEE 802.11.

In other words, the access point 14 and the terminal 200 first check whether or not there is a carrier based on the CSMA/CA. If it is determined that there is no carrier (that is, if there is no terminal using a wireless channel), transmission is performed after lapse of a predetermined time. Since the same transmitter (Tx) or receiver (Rx) uses the same transmission medium, only one of transmission (Tx) and reception (Rx) can be performed at a time.

Further, if collision with other terminals occurs in transmission, next carrier is determined using a back-off algorithm.

The eBTS 300 is connected to a Base Station Controller (BSC) 5a, and the BSC 5a is connected to a Mobile Station Controller (MSC) 3 that is a voice core network connected with a Public Switched Telephone Network (PSTN) 4 and performing a voice communication, and connected to a Packet Data Serving Node (PDSN) 2 that is a data core network connected to Internet 1 and performing a data communication. The MSC 3 performs an exchange function for the voice communication using the cellular mobile communication system, and the PDSN 2 performs a packet exchange function for the data communication using the cellular mobile communication system.

The eBTS 300 sets and manages a wireless link with its managing terminals (not shown), using the cellular frequency, and provides a service for the terminal 200 connected through the WLAN.

In other words, the eBTS 300 sets, maintains, and unsets the wireless link with a cellular terminal (not shown) for wirelessly communicating using the cellular frequency band.

Further, the eBTS 300 receives information from the terminal 200 connected through the tunnel in the WLAN area, and transmits the received information to the MSC 3 or the PDSN 2 through the BSC 5a.

The terminal 200 receives a beacon from the access point 14 and performs an association process for the access point 14 using the received beacon, and is assigned an IP address from a gateway 12 using Dynamic Host Configuration Protocol (DHCP). After that, the terminal 200 sets the tunnel up to the eBTS 300 using a tunneling method such as User Datagram Protocol (UDP).

At this time, data and signaling transmission between the BSC 5a and the eBTS 300 is performed using a standard (for example, Abis) or an Inter Processor Communication (IPC) shared by each equipment enterprise.

The BSC 5a recognizes the eBTS 300 as one of its lower BTSs, and prepares information for the same cellular service and transmits the prepared information to the eBTS 300 using the Abis or a separate IPC. The eBTS 300 receives the transmitted information, and transmits the received information to the terminal 200, using a previously set tunnel with the terminal 200. Similarly, the eBTS 300 receives the information from the terminal 200 through the tunnel, and transmits the information to the BSC 5a through the Abis or a separate IPC.

An exemplary method for setting the tunnel between the terminal 200 and the eBTS 300 will be described below.

When the terminal 200 uses a UDP tunnel up to the eBTS 300, the terminal 200 transmits a tunnel set request message to the eBTS 300, using its stored IP address and a UDP port of the eBTS 300. The request message can include a terminal ID (International Mobile Subscriber Identity (IMSI), IP address, and MAC address) and a user ID (for example, Network Access Identifier (NAI)), and can include information for indicating the type of data (CS signaling, CS data, PS signaling, PS data, and other information).

The eBTS 300 receives the tunnel set request message from the terminal 200, and periodically transmits a message having BSC relation information such as a cell ID to the corresponding terminal 200 having a source port number. By doing so, the UDP tunnel is completed between the terminal 200 and the eBTS 300. Henceforth, the UDP tunnel is maintained and used to exchange necessary information.

In the meantime, when the terminal 200 uses a GRE tunnel up to the eBTS 300, the terminal 200 transmits a message including the terminal ID, the user ID, and a desired option (the use of a sequence number, the application of encryption, and the like), to the eBTS 300. The eBTS 300 assigns necessary options, and transmits a GRE message using the corresponding option. The terminal 200 receives the GRE message, and transmits a confirmation message to the eBTS 300 using the received GRE message. Accordingly, the GRE tunnel is completed. Henceforth, the GRE tunnel is maintained and used to exchange necessary information.

After the completion of the tunnel, the terminal 200 does not need to separately include the terminal ID and the user ID except for a special case. The BSC 5a regularly transmits information representing the cell ID and other network states, to all BTSs 5a and 5b. The eBTS 300 receives the information from the BSC 5a, and transmits the received information to the terminal 200.

The terminal 200 periodically transmits a position registration message of the cellular service to the BSC 5a. When there is no data to be transmitted, a message is transmitted to the eBTS 300 within a predetermined time so as to maintain the tunnel. When the eBTS 300 does not receive a tunnel maintenance message from the terminal 200, it transmits a registration request message to the terminal 200, and waits for a predetermined time. For example, when the eBTS 300 transmits the registration request message to the terminal 200 more than three times and does not receive a response from the terminal 200, it unsets the tunnel with the terminal 200.

If the terminal 200 does not also receive periodical network information from the eBTS 300, it transmits a message requesting the eBTS 300 to send the network information, and waits for a predetermined time. If the terminal 200 does not receive a response from the eBTS 300 after lapse of the predetermined time, it repeats the same operation, for example, repeating three times a request to the eBTS 300 to send the network information. If the terminal 200 still does not receive the network information from the eBTS 300, it unsets the tunnel and performs a process of setting a new tunnel.

Whereas, in a conventional setting BSC manages the BTS, assigns the wireless channel to the terminal, and controls the transmission output of the base station, according to an exemplary embodiment of the present invention, control of the transmission output of the base station from the BSC does not have a special meaning, and the BSC 5a performs a similar operation with other BTSs 6a to recognize the eBTS 300 in the same manner as other BTSs 6a. An access point of an exemplary embodiment of the present invention may perform operations analogous to those of an access point of a conventional WLAN. According to an exemplary embodiment of the present invention, the eBTS 300 performs a function of relaying information between the terminal 200 and the BSC 5a, and performs an additional function of periodically transmitting the cellular network information linked with the cellular network.

An example of a cellular service method of the terminal, which is positioned in the WLAN area, in the above described exemplary mobile communication system will be described below.

A connection between the eBTS 300, the BSC 5a and the MSC 3 according to an exemplary embodiment of the present invention may be analogous to a connection between the conventional BTS 6b, BSC 5b and MSC3. According to an exemplary embodiment of the present invention, a conventional format for a message, which is communicated for call processing between the BTS 6b, the BSC 5b and the MSC 3 may be used.

Conventionally, if the MSC 3 transmits a channel assignment request message to the BSC 5b, the BSC 5b commands the BTS 5b in response to the received channel assignment request message to assign the wireless channel to the terminal, and if the BTS 6b assigns the wireless channel to the terminal, the BSC 5b performs the MSC 3 that the wireless channel assignment is successfully performed.

Conventionally, channel assignment message is communicated between the BTS 6B, the MSC 3 and the BSC 5b for channel assignment. According to an exemplary embodiment of the present invention, the channel assignment message is communicated between the eBTS 300, the BSC 5a and the MSC 3. According to an exemplary embodiment of the present invention, a conventional format may be used for channel assignment message, but not the conventional channel assignment message. Accordingly, in contradistinction to a conventional cellular network, in an exemplary embodiment of the present invention even though the channel assignment message is communicated, the wireless resource of the cellular network is not assigned. That is because in an exemplary implementation of the present invention, the wireless link uses the wireless resource assigned from the WLAN.

Accordingly, in an exemplary implementation of the present invention, the MSC 3 downloads the channel assignment message to the eBTS 300 through the BSC 5a to perform a function of informing that the corresponding terminal is called, and the eBTS 300 uploads the response message to the MSC 3 in response to the channel assignment message to perform a function of informing that the terminal recognizes that the terminal is called. Based on the foregoing, an incoming call process will be described below.

If the BSC 5a receives a paging request message from the MSC 3, it transmits a response request message to the terminal 200. If the terminal 200 responds to the response request message of the BSC 5a, the BSC 5a checks a response of the terminal 200, and sends a paging response message to the MSC 3. The paging response message includes information on a BSC's request for setting a trunk channel with the MSC 3. The MSC 3 sends the channel assignment message in response to the paging response message while completing the setting of the trunk channel with the BSC 5a.

According to an exemplary embodiment of the invention, the BSC 5a may perform a channel assignment process based on a conventional call setting process. The eBTS 300 receives the channel assignment message, and transmits a message having its UDP port information to the terminal 200. The terminal 200 stores the UDP port information of the eBTS 300 using the received message, determines the UDP port to be used to transmit a voice signal, includes information on the determined UDP port in a confirmation message responsive to the channel assignment message, and transmits the confirmation message to the eBTS 300. The eBTS 300 receives the confirmation message, stores the corresponding UDP port information, completes a preparation for the voice signal to be transmitted to the terminal 200, using the corresponding UDP port, and transmits a channel assignment completion message to the MSC 3. After that, the MSC 3 completes remaining call processing, and communicates using a Pulse Code Modulation (PCM) voice signal with the BSC 5a using Time Division Multiplexing (TDM). The BSC 5a converts the voice signal in a format of EVRC, loads the voice signal on Abis, and transmits the voice signal to the eBTS 300. The eBTS 300 communicates with the terminal 200 using the UDP port, which is set through the above process.

Next, an outgoing process for a CDMA-2000 system for example, will be described below.

The terminal 200 transmits an origination message to the eBTS 300, using the predetermined tunnel. The eBTS 300 receives the origination message from the terminal 200, and transmits the origination message to the BSC 5a through Abis. The BSC 5a receives the origination message, sends a CM service request message to the MSC 3, and requests to set the trunk channel with the MSC 3. The MSC 3 responds to the eBTS 300 using the channel assignment response message, completes the setting of the trunk channel between the MSC 3 and the BSC 5a, and sends the channel assignment message to the eBTS 300. The eBTS 300 transmits a message having its UDP port information to the terminal 200 through the tunnel according to a conventional call setting process. The terminal 200 stores the UDP port information of the eBTS 300 using the received message, determines the UDP port to be used to transmit a voice signal, includes information on the determined UDP port in the channel assignment response message, and transmits the response message to the eBTS 300. The eBTS 300 stores the corresponding UDP port information, completes a preparation for the voice signal to be transmitted to the terminal 200, using the corresponding UDP port, and informs as if assignment of a CDMA air channel is completed as required by the BSC 5a through the Abis. However, as aforementioned, the CDMA air channel is actually not assigned, and the wireless resource of the WLAN is assigned by the WLAN. The BSC 5a receives and transmits the channel assignment completion message to the MSC 3. After that, the MSC 3 completes the remaining call processing, and communicates a Pulse Code Modulation (PCM) voice signal with the BSC 5a using Time Division Multiplexing (TDM). The BSC 5a converts the voice signal to EVRC format and communicates with the eBTS 300 through Abis. The eBTS 300 communicates the EVRC formatted voice signal with the terminal 200 using the UDP port, which is set through the above process.

In an exemplary embodiment of the present invention, since the terminal having the WLAN interface module can be in the cellular service in the WLAN service area, if the terminal capable of using the cellular frequency band has the WLAN interface module, the terminal can be connected to the cellular service network using the WLAN service-dedicated wireless resource, without using the cellular service-dedicated wireless resource, thereby being in the cellular service.

Further, since exemplary an implementation of the present invention can enable the WLAN system to be associated with the cellular mobile communication system, it can provide a possibility of various communication services. For example, since the terminal is connected to the cellular service network using the WLAN service-dedicated wireless resource, thereby being in the cellular service, an exemplary implementation of the present invention may also provide an opportunity of service provider's attracting WLAN subscribers as service clients in relation with an issue of billing.

While exemplary implementations of the present invention have been described with reference to exemplary embodiments thereof, it will be understood by those skilled in the art that various changes in form and detail may be made therein without departing from the spirit and scope of the present invention as defined by the following claims.

What is claimed is:

1. A cellular mobile communication system comprising:
a Wireless Local Area Network (WLAN) comprising a wireless resource using a WLAN-dedicated frequency band;
a base station of a cellular network connected to the WLAN through a wired network; and
a terminal setting a tunnel with the base station of the cellular network using the wireless resource of the WLAN, and connected to the cellular network through the set tunnel to perform call processing.

2. The system according to claim 1, wherein the terminal sets the tunnel with the base stationusing at least one of a User Datagram Protocol (UPD), a Generic Route Encapsulation (GRE) protocol, and a General Packet Radio Service Tunneling Protocol (GTP).

3. A terminal for a cellular mobile communication system, the terminal comprising:
a Wireless Local Area Network (WLAN) interface module assigned a wireless resource provided from a WLAN and communicating with the WLAN using a WLAN-dedicated frequency band;
a tunnel processor which sets and manages a tunnel with a base station of a cellular network connected to the WLAN through a wired network, using the wireless resource provided from the WLAN through the WLAN interface module; and
a call processor connected to the cellular network through the set tunnel, and performing call processing.

4. The terminal according to claim 3, further comprising a cellular interface module assigned the wireless resource provided from the cellular network and communicating with the cellular network using a cellular-dedicated frequency band.

5. The terminal according to claim 3, wherein the tunnel processor sets the tunnel with the base station using at least one of a User Datagram Protocol (UDP), a Generic Route Encapsulation (GRE) protocol, and a General Packet Radio Service Tunneling Protocol (GTP).

6. A cellular mobile communication method comprising the steps of:
transmitting, by a terminal, a tunnel set request message to a base station of a cellular network, which is connected to a Wireless Local Area Network(WLAN) through a wired network using a wireless resource assigned from the Wireless Local Area Network(WLAN);
storing, by the base station of the cellular network, terminal information extracted from the received request message and setting the tunnel with the terminal in response to the tunnel set request message from the terminal; and
connecting, by the terminal, to the cellular network through the tunnel, which is set between the terminal and the base station, and performing call processing.

7. The method according to claim 6, further comprising the step of periodically transceiving data for determining whether or not tunnel setting is maintained between the terminal and the base station of the cellular network.

8. The method according to claim 6, wherein the message comprises at least one of information on a terminal ID, a user ID, and a type of data.

9. The method according to claim 8, wherein the terminal ID is an International Mobile Subscriber Identity (IMSI).

10. The method according to claim 8, wherein the user ID is a Network Access Identifier (NAI).

11. The method according to claim 8, wherein the type of data comprises at least one of CS signaling, CS data, PS signaling, and PS data.

12. A cellular mobile communication method comprising the steps of:
transmitting, by a terminal, a tunnel set request message to an enhanced Base Station Controller (eBSC) of a cellular network, which is connected to a Wireless Local Area Network(WLAN) through a wired network using a wireless resource assigned from the Wireless Local Area Network(WLAN);
storing, by the eBSC of the cellular network, terminal information extracted from the received request message and setting the tunnel with the terminal in response to the tunnel set request message received from the terminal; and
connecting, by the terminal, to the cellular network through the tunnel, which is set between the terminal and the eBSC, and performing call processing.

13. The method according to claim 12, wherein the performing of the call processing comprises the steps of:
when a predetermined terminal is called by a party, downloading, by an Mobile Station Controller (MSC), a channel assignment message to the eBSC;
uploading, by the eBSC, a channel assignment confirmation message to the MSC in response to the channel assignment message; and
transmitting, by the MSC, the channel assignment confirmation message to the party, and initiating voice signal communication.

14. The method according to claim 12, wherein the performing of the call processing comprises the steps of:
transmitting, by the terminal, a call outgoing message to the eBSC using a predetermined tunnel;
requesting, by the eBSC, the MSC of the cellular network to set a trunk channel, setting a channel between the eBSC and the MSC, and transmitting a message comprising User Datagram Protocol (UDP) port information to be used for a new traffic channel to the terminal;
receiving, by the terminal, the message from the eBSC, storing the UDP port information of the eBSC, determining a UDP port to be used for voice signal transmission, and transmitting a traffic channel assignment confirmation message comprising the determined UDP port information to the eBSC; and
storing, by the eBSC, corresponding UDP port information, completing a preparation operation for transmitting a voice signal to the terminal using the corresponding UDP port, and transmitting a traffic channel assignment completion message to the MSC.

15. A cellular mobile communication method comprising the steps of:
transmitting, by a terminal, a tunnel set request message to an enhanced Base Transceiver Station (eBTS) of a cellular network, which is connected to a Wireless Local Area Network(WLAN) through a wired network using a wireless resource assigned from the Wireless Local Area Network(WLAN);
storing, by the eBTS of the cellular network, terminal information extracted from the received request message and setting the tunnel with the terminal, according to the tunnel set request message received from the terminal; and
connecting, by the terminal, to the cellular network through the tunnel, which is set between the terminal and the eBTS, and performing call processing.

16. The method according to claim 15, wherein the performing of the call processing comprises the steps of:
when a predetermined terminal is called by a party, downloading, by an Mobile Station Controller (MSC), a channel assignment message to the eBTS through a Base Station Controller (BSC);
uploading, by the eBTS, a channel assignment response message to the MSC through the BSC, in response to the channel assignment message; and
transmitting, by the MSC, the channel assignment response message to the party, and initiating voice signal communication.

17. The method according to claim 15, wherein the performing of the call processing comprises the steps of:
transmitting, by the terminal, a call outgoing message to the BSC of the cellular network via the eBTS using a predetermined tunnel;
requesting, by the BSC, the MSC of the cellular network to set a trunk channel, setting a channel between the BSC and the MSC, and transmitting a channel assignment message to the eBTS;
transmitting, by the eBTS, a message comprising User Datagram Protocol (UDP) port information to the terminal through the tunnel;
receiving, by the terminal, the message from the eBTS, storing the UDP port information of the eBTS using the received message, determining a UDP port to be used for voice signal transmission, and transmitting a traffic channel assignment confirmation message comprising the determined UDP port information to the eBTS; and
storing, by the eBTS, corresponding UDP port information, completing a preparation operation for transmitting a voice signal to the terminal using the corresponding UDP port, and transmitting a traffic channel assignment completion message to the MSC through the BSC.
